(19) United States
(12) Patent Application Publication
(10) Pub. No.: US 2019/0271137 A1
(43) Pub. Date: Sep. 5, 2019

(54) HOME PROTECTION AND CONTROL SYSTEM

(71) Applicant: ARMANDO GARCIA VIVEROS, RIO GRANDE CITY (MX)

(72) Inventor: ARMANDO GARCIA VIVEROS, RIO GRANDE CITY (MX)

(21) Appl. No.: 15/909,320

(22) Filed: Mar. 1, 2018

(51) Int. Cl. E03B 7/07; G06F 3/0484; G06F 3/0481

(52) U.S. Cl. CPC E03B 7/075; G06F 3/04817; G06F 3/04842; E03B 7/071

(57) ABSTRACT

A system that achieves continuous supervision of all the installations of the home, detection of any type of incident in real time and the indication of the incident both locally and remotely, in addition to being able to carry out actions related to protecting the home, such as shutting off the water supply, opening the sprinklers, etc. To do so, it comprises: a touch screen that acts as an interface based on the use of a series of icons, by which the interaction and manipulation of the system is carried out, an electronic card responsible for controlling the system in its entirety, and a series of sensors placed on different parts of the different installations to be monitored and that are connected with the electronic card.

### OBJECT OF THE INVENTION

The object of the present invention is, as the title of the invention establishes, a home protection and control system that enables the installations of the home to be controlled both locally and remotely.

The present invention is characterized by the special configuration and combined arrangement of distinct elements and features that make it an effective and simple protection system against incidents.

Therefore, the present invention falls within the field of control systems and particularly among systems used in the home.

### BACKGROUND OF THE INVENTION

In the state of the art, home automation is known, which consists of systems able to automate a dwelling or building of any type, providing energy management, security, well-being and communication services, and which can be integrated by means of interior and exterior communication networks, wired or wireless, and the control of which has a certain ubiquity, from inside and outside the home. It could be defined as the integration of the technology in the intelligent design of a closed facility.

However, if the home automation of the state of the art offers the possibility of remote control, none of said systems enables warnings to be sent if there is an incident, breakdown, etc.

One of the most common problems that a home can have is in the plumbing due to water leaks, either because of the age of the house, poor maintenance, extreme climate or low-quality materials.

This problem is accentuated in homes made with materials weak against moisture, such as wood, creating costly problems for the owners of the houses.

Therefore, the object of the present invention is to design a system that is able to detect any type of incident or breakdown, in addition to sending a warning both locally and remotely, developing a protection and control system for the home like the one described below and the essential nature of which is set out in claim 1.

### DESCRIPTION OF THE INVENTION

The object of the present invention is a home protection and control system, in other words, a system that is able to continuously monitor the different installations, both electrical, gas, and plumbing, such that when an incident is detected, for example, a water leak, a gas leak, where once the incident is detected, it communicates it and sends a warning both locally and remotely and proceeds to act according to how it is programmed.

With this protection system, monetary losses are avoided in subsequent home repairs, and human losses are also avoided since problems in gas installations can be fatal, causing accidents of intoxication or explosions.

The system object of protection and control comprises:
a touch screen that acts as an interface based on the use of a series of icons, texts and numbers that make up a graphic interface by which the interaction and manipulation of the system is carried out.
an electronic card responsible for controlling the system in its entirety, for both the input sensors and the communication output with the touch screen, as well as the wireless connection.
A series of sensors placed on different parts of the different installations to be monitored and that are connected to the electronic card.

The electronic control card comprises a power source, a microcontroller, a series of controlled inputs and outputs, wireless communication means, a real-time clock.

The touch screen and the electronic card communicate by means of connection means with RS-232 protocol.

Therefore, with the described system, continuous supervision of all the installations of the home, the detection of any type of incident in real time and the indication of the incident both locally and remotely are achieved, in addition to being able to carry out actions related to protecting the home, such as shutting off the water supply, opening the sprinklers, etc.

Except when indicated otherwise, all of the technical and scientific elements used in this specification have the meaning commonly understood by a person with average skill in the art to which this invention belongs. When this invention is put into practice, methods and materials may be used that are similar or equivalent to the ones described in this specification.

Throughout the description and claims, the word “comprise” and its variants are not intended to exclude other technical characteristics, additions, components or steps. For those skilled in the art, other objects, advantages and characteristics of the invention may be deduced from both the description and the practical use of the invention.

### EXPLANATION OF THE FIGURES

As a complement to the present description, and for the purpose of helping to make the characteristics of the invention more readily understandable, in accordance with a preferred practical exemplary embodiment thereof, said description is accompanied by a set of drawings constituting an integral part of the same, which by way of illustration and not limitation represent the following.

FIG. 1 shows a simplified general representation of the two main elements of the home protection and control system.

FIG. 2 shows a schematic representation of the connectivity and control of the microcontroller with the rest of the elements of the electronic card.

### PREFERRED EMBODIMENT OF THE INVENTION

With reference to the figures, a preferred embodiment of the invention proposed is described below.

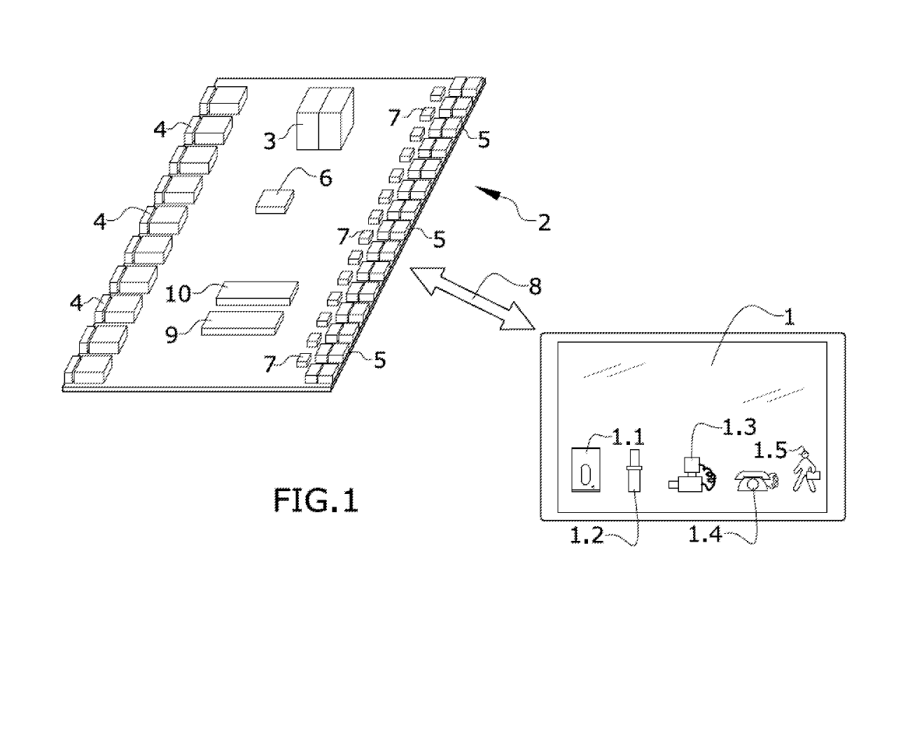

FIG. 1 shows a touch screen (1) on which there are several icons represented, and that is in communication with an electronic control card (2).

Different icons are shown on the touch screen (1).
A first icon (1.1) for accessing the menu for the water heaters.
A second icon (1.2) for accessing the menu for the water diffusers or sprinklers.
A third icon (1.3) for accessing the menu for the main valves.
A fourth icon (1.4) for accessing the contact numbers of the repair technicians.
A fifth icon (1.5) for accessing the menu for the settings.

Once each of the submenus has been accessed by pressing the corresponding icon, the different elements can be programmed.

Thus, once entering the submenu for the heaters, it is possible to program each of the heaters that may exist, based on the different days of the week, hours and minutes for being on and off.

By entering the submenu for the sprinklers, it is also possible to select the day of the week, the availability thereof and the hour and minute of activation.

In the submenu for the valves, it is possible to select the valves, know the status thereof and be able to change it.

In the submenu for the technicians, a summary is shown of the technicians trained for different areas of the home, such as air conditioning, sprinklers, plumbing and electricity.

The settings submenu enables the user settings and the information of the device to be accessed.

The touch screen also has other submenus such as:
Menu for accessing password of the technician
Menu for selecting technician settings
Menu for setting sensor status
Menu for setting relay status.
Menu for changing password
Menu for selecting Wi-Fi connection
Menu for inputting Wi-Fi password
Menu for inputting email for notifications
Menu for setting the date.

The electronic control card (2) comprises among other elements:
A power supply (3)
A microcontroller (6) that can be an ATMEGA 2560 microcontroller in a possible embodiment
A series of inputs (5) that could be 36 inputs.
A series of outputs (4) that could be 18 outputs.
A series of operational input control amplifiers (7) that are integrated LM358 amplifiers in a possible embodiment.
A real-time clock (9)
Wireless communication means (10).

The system also has a series of sensors placed on different parts of the different installations to be monitored and that are connected to the electronic card.

The communication between the touch screen (1) and the electronic card (2) in a possible non-limiting embodiment can be by means of USART communication and transmitted by means of the RS-232 protocol. This communication and transmission protocol is used due to the possible medium-large distances between the interface and the electronic card; with this method communication problems are prevented.

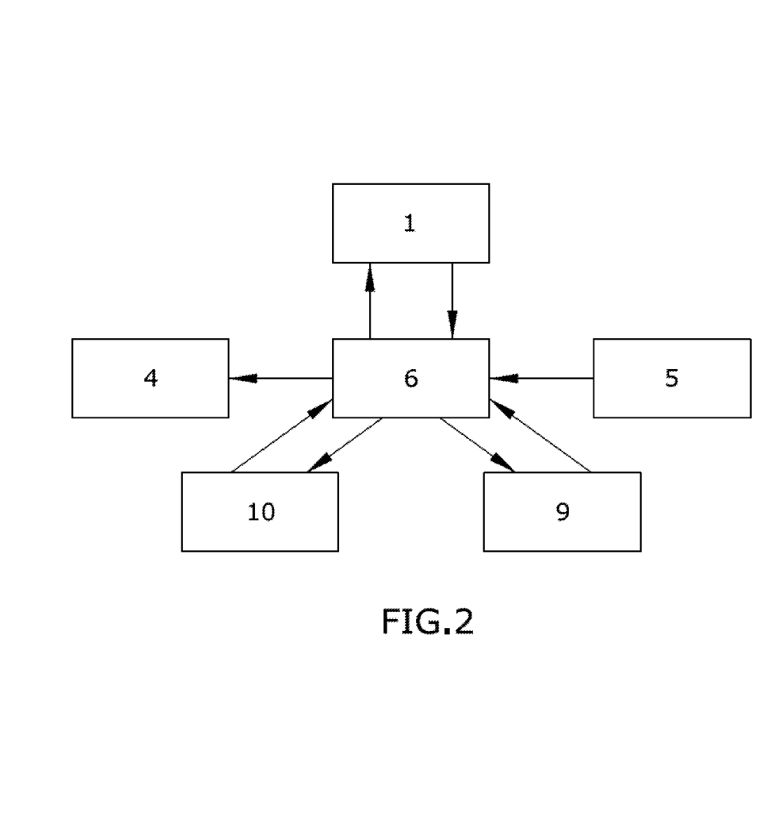

FIG. 2 shows the microcontroller (6) that is in bidirectional communication with the touch screen (1), with the inputs (5), with the outputs (6), with the wireless communication means (10), and with the real-time clock (9).

Having thus adequately described the nature of the present invention, as well as how to put it into practice, it must be noted that, within its essential nature, the invention may be carried out according to other embodiments differing in detail from that set out by way of example, which the protection sought would equally cover, provided that the fundamental principle thereof is not altered, changed or modified.

1. A home protection and control system comprising
a touch screen that acts as an interface based on the use of a series of icons, texts and numbers that make up a graphic interface by which the interaction and manipulation of the system is carried out;
an electronic card responsible for controlling the system in its entirety, for both the input sensors and the communication output with the touch screen, as well as the wireless connection;
a series of sensors placed on different parts of the different installations to be monitored and that are connected to the electronic card;
the electronic control card:
a power supply;
a microcontroller;
a series of inputs;
series of outputs;
a series of operational input control amplifiers;
a real-time clock;
wireless communication means;
with the previous elements, the system carries out tasks such as:
supervising the status of the installations of a home;
detecting any type of incident in real time through a series of sensors and the indication of the incident both locally and remotely; and
carrying out actions related to protecting the home, such as shutting off the water supply, opening the sprinklers.

2. The home protection and control system according to claim 1, wherein the microcontroller is an ATMEGA 2560 microcontroller, the number of inputs is 36 and the number of outputs is 18.

3. The home protection and control system according to claim 1, wherein the inputs are controlled by the operational input control amplifiers that are integrated LM358 amplifiers.

4. The home protection and control system according to claim 1 wherein the touch screen has the following icons:
a first icon for accessing the menu for the water heaters;
a second icon for accessing the menu for the water diffusers or sprinklers;
a third icon for accessing the menu for the main valves;
a fourth icon for accessing the contact numbers of the repair technicians;
a fifth icon for accessing the menu for the settings.
